(19) United States
(12) Patent Application Publication
(10) Pub. No.: US 2007/0198466 A1
(43) Pub. Date: Aug. 23, 2007

(54) By owner MLS business method

(76) Inventors: Gregory Sullivan, Boca Raton, FL (US); Dominic A. Muttillo, Boca Raton, FL (US)

Correspondence Address: Robert J. Van Der Wall;Gables One Tower, Suite 1275, 1320 South Dixie Highway, Coral Gables, FL, 33146, US

(21) Appl. No.: 11/710,321

(22) Filed: Feb. 22, 2007

Related U.S. Application Data
(60) Provisional application No. 60/775,848, filed on Feb. 23, 2006.

(51) Int. Cl. G06F 17/30

(52) U.S. Cl. 707/1

(57) ABSTRACT

The present invention is a business method for the inventor company which operates through an internet web site a By Owner multiple listing service that pools the multiple listing service data from a multiplicity of By Owner real estate listing companies, both local and national in nature. The company's web site has software with an architecture that contemplates sellers listing their properties with a variety of By Owner LCs who elect to become part of the By Owner multiple listing service database by submitting data on their seller's/customer's listings to the web site searchable database. The database may be accessed by users through the company's web site. The invention contemplates that buyers are able to contact sellers based on information shown in the searchable database listings, and potential sellers who decide to sell their property are referred to an originating LC to seller property and By Owner multiple listing service business revenue is generated off of advertising as well as per unit transaction fees.

### BACKGROUND OF THE INVENTION

1. Field of the Invention

The present invention relates to the business of the sale of real estate using a “By Owner” format, as opposed to the use of realtors. More specifically the invention concerns a business method utilizing an internet web site that electronically combines and makes available for potential buyers and investors (“users”) searching the listings of properties for sale from a multiplicity of By Owner listing companies (“LCs”) whether these By Owner LCs are local or national in scope. To avoid state mandated licensing issues governing the conduct of realtors, the business method does not contemplate sharing commissions paid by sellers, but instead shares fees charged by the various By Owner LCs when their products are purchased through the business method searchable internet web site.

2. Description of the Prior Art

It is well known that the traditional method of selling houses and other real estate is through the services of realtors and real estate brokers who are compensated for their listing, advertising and selling efforts by commissions paid by the sellers. The latter industry has developed what is commonly referred to as a multiple listing service or MLS that in recent years has been computerized.

A number of years ago there evolved an alternative to the foregoing in the form of a By Owner service. The By Owner service avoids the employment of realtors and real estate brokers, frequently to avoid the payment of commissions that customarily amount to a percentage of the sale price. Instead, By Owner companies charge a flat much more modest fee for the seller's use of a By Owner listing company (“LC”) and for information that enables and facilitates the sale of real estate by its owner without the use of realtors and real estate brokers.

These By Owner LCs may be local or national in scope. Each of these By Owner LCs have set up its own internet web site with potential buyers to search available properties. However, there has been no connection between the various By Owner LCs up to the time of the present invention. Thus there has been no way for a potential buyer to search the listings on line of all By Owner LCs in a single database. The present invention was created primarily to solve that problem.

### SUMMARY OF THE INVENTION

Bearing in mind the foregoing, it is a principal object of the present invention to provide a database by which users can search the listings of multiple By Owner LCs at a single internet web site.

A related object of the invention is to provide a potential buyer with access to listings generated by the By Owner LCs of which the user may well have never heard.

Another related object of the invention is to greatly increase the number of properties a potential purchaser can research in a small amount of time.

An additional object of the invention is to augment and increase the business of the various By Owner multiple LCs who are referred business by the company operating the internet web site because potential sellers are referred to By Owner LCs by the web site.

A further object of the invention is to establish a new business for the company that has invented the business method, set up the internet web site through which it operates, and which maintains and operates the web site.

Other objects and advantages will be apparent to those skilled in the art upon reference to the following descriptions and the accompanying drawing.

In accordance with a major aspect of the present invention there is provided a business method for the inventor company which operates through an internet web site and a By Owner multiple listing service that pools the multiple listing service data from a multiplicity of By Owner LCs, both local and national in nature. The company's web site has software with an architecture that contemplates sellers listing their properties with a variety of By Owner LCs who elect to become part of the By Owner multiple listing service database by submitting data on their seller's/customer's listings initially to a site staging database. The site staging database is where LCs' data is loaded, which contains raw data feeds to update and which also searches to prevent duplication. Basically at this site the data is organized so that it can be transferred in electronic transfer language to a searchable database which may be accessed by users through the company's web site. The invention contemplates that buyers are able to contact sellers based on information shown in the searchable database listings, an LC can update information on their properties that are carried in the searchable database of the By Owner multiple listing service, potential sellers who decide to sell their property are referred to an originating LC to sell property and By Owner multiple listing service business revenue is generated off of advertising as well as per unit transaction fees.

ByOwnerMLS (“BOMLS”) is a real estate search engine that brings together virtually every “for sale by owner” listing. Consumers can search the most comprehensive resource of “for sale by owner” home, condominium, time share, rental, vacation home, town home, multi-family, vacant land and commercial listings posted on the web. The LCs upload and modify their inventory as it changes, providing users an accurate representation every “for sale by owner” listing.

### BRIEF DESCRIPTION OF THE DRAWING

The drawing is a block diagram showing data flow architecture among buyers and sellers, By Owner LCs and the web site of the By Owner multiple listing service referred to herein as the company.

### DETAILED DESCRIPTION OF THE PREFERRED EMBODIMENTS

As required, detailed embodiments of the present invention are disclosed herein; however, it is to be understood that the disclosed embodiments are merely exemplary of the inventions which may be embodied in various forms. Therefore, specific structural and functional details disclosed herein are not to be interpreted as limiting, but merely as a basis for the claim and as a representative basis for teaching one skilled in the art to variously employ the present invention in virtually any appropriately detailed structure.

The business method of the present invention is operated by the company creating a portal for all “for sale By Owner” real estate LCs to have a central location for advertising their inventory.

The “for sale By Owner” real estate industry is comprised of many different internet web sites that advertise each LC's inventory via the internet. Some sites cover local areas only, while others may cover the entire United States and other countries. The fragmented nature of this industry previously made it impossible for buyers to search the entire nationwide inventory from just one location. By combining all of the LCs, or many of them, together on to one web site the company becomes one of the most powerful real estate information services in the world, surpassed only by realtor.com in total inventory.

The company is an advertising portal and not a real estate brokerage. The company offers the opportunity for each LC to market inventory to prospective buyers and investors on a global scale through the world wide web. The company does not receive compensation through commissions paid by sellers, but it does share in fees charged by the various LCs when their products are purchased through the company web site. It also receives revenue from advertisers on the web site.

The company offers the opportunity for each LC to market their other services to real estate owners (“sellers”). These services include but are not limited to real estate marketing, real estate advertising services, multiple listing services (MLS) through local real estate boards and realtor.com, marketing brochures, selling of real estate signs, rental services, real estate marketing magazines, television, world wide web advertising, and radio advertising.

Users have the ability to contact sellers through the company's web site via e-mail, phone, personal representative, real estate agent and/or broker, instant message and/or fax message board maintained by the company. These methods are the same methods that LCs offer to their customers. The company also offers a message service for both users and sellers.

The system operates as follows: each LC obtains inventory through their own business methods. They each obtain an electronic record of each seller's listing and provide the same data fields that they have collected to the company on a daily or more frequent basis. Listing fields include but are not necessarily limited to the following fields: type of property/asset, such as home, raw land, a condo, a mobile home, a rental, commercial property, etc. The property/asset description includes the property address, its price, the number of bedrooms, the number of baths, the land size, the property use, the pictures of the property, description of the property, availability, text, amenities, homeowner association/condominium dues, and the like. The web site provides a method to contact the seller including e-mail, phone, fax, and a message board.

The company contracts with the LC to daily upload inventory to the company's servers in a text or XML format (“Extensible Markup Language”). This provides a flexible way to create common information formats and share both the format and the data on internet, intranets, and elsewhere. The company then connects with the LC's server via a HTTP (“Hyper Text Transfer Protocol”) connection, a very standard method of transferring information between internet sites. HTTP provides a way to log in to another internet site for the purpose of retrieving and/or sending files. The company downloads the LC's data and formats it to be inserted into the company database record by record. Removal of duplicate listings and other validation is done at the time of inserts/updates. The daily feed includes changes to the LC's database of listings that have been added, removed or modified. This process arranges the LCs' data into a standardized format that becomes viewable to all users when it is dispatched to the searchable database on the company's web site.

The company's web site has software with an architecture that contemplates sellers listing their properties with a variety of By Owner LCs who elect to become part of the By Owner multiple listing service. The LCs then update the content of their data file with the modifications to their database.

The invention contemplates that buyers are able to contact sellers based on information shown in the searchable database listings, an LC can update information on their properties that are carried in the searchable database of the By Owner multiple listing service, potential sellers who decide to sell their property are referred to an originating LC to sell property and By Owner multiple listing service business revenue is generated off of advertising as well as per unit transaction fees.

The company's web site includes pages such as a home page with an introduction to the service with searchable fields for users to find inventory via various search methods including a zip code search, an advanced search to be able to search by beds, baths, zip code, area code, price range, type, or a map search. A link is provided to a privacy policy page, a contact us page, and an about us page. Advertising locations are provided for LCs and others on these various pages.

Furthermore, the page after the initial search page displays results of initial search with a brief description of each listing and inclusive of a link to display all other details of each other listing.

The details page includes all details as to each listing that was originally provided by the LC as well as a method for a user to save a particular listing to that user's profile. Each LC has a link from the details page to a custom page of their own web site that describes their service and gives a description of the process of listing an asset with the LC. Also included is that the company offers a link on this page for additional information that may be linked to a partner that provides demographics, sales history reports, or public record information.

The details page further has a link for e-mailing a particular listing to a friend, it has advertising openings for the local level of a particular LC, and all clicks to each listing are logged. The space for advertising includes such things as finding a realtor, obtaining a loan, obtaining an appraisal, a credit check and the like.

The user profile includes the ability for a user to save searches in various formats such as a zip code search and have the system e-mail new listings to users as they are added. The e-mail is designed to include only a minimal amount of information on each listing with a link back to the site for more details or to a user page to sell all new listings.

One of the objectives of the company web site is to secure new seller listings for real estate sales. Each details page offers branding to original LCs along with a link to other properties offered by that LC and a link to list a property with one of the LCs.

When a user clicks on a “list your home with a certain LC” field, they are linked to a company and LC co-sponsored page that gives a brief introduction to the service and a electronically traceable link or an initial form that collects preliminary information from the seller, logs all the collected information, and passes the same to the LC for its handling of the remainder of the listing process.

Some features of the system include the following: Pictures are all to be of similar resolution, the database has the ability to track all property details separately, such as beds, baths, zip code, remarks, style, acquire date, remove date, etc. Systems are also prepared to handle rental property, it has the ability to sell different advertising on different pages such as on a zip code or on a county level, including the use of banners and text links. Software facilitates search engines being able to land on any of county, city, state, country, zip code databases. It also facilitates tracking affiliate traffic and pays out accordingly. The database is standardized for partners to be able to FTP (“File Transfer Protocol”) on daily updates. Each listed property has an ID associated with it which is computer generated. BOMLS' primary purpose is to enable the user to quickly and efficiently search through tens of thousands of listings using the most common search criteria. BOMLS advanced search component delivers sub-second response time and complete and relevant listing results. The search results are presented to the user in a friendly and self explanatory format, giving the user a clear idea of the property details, where it is located, what it looks like, as well as a brief property description. The user has the ability to browse through the pages of search results and if necessary click on any listing to drill down and view the property details page. The property details page contains a complete list of all of the property attributes (address, bedrooms, baths, full description, etc . . . ) as well as available images. Each listing will allow users to contact the property owner either through using BOMLS property contact form, a link back to the LC's site, or by displaying the phone number for the person who listed the property. Each listing contains a link to the LC's designated page. If no contact information is available, a link to the corresponding listing page on the LC's website is provided.

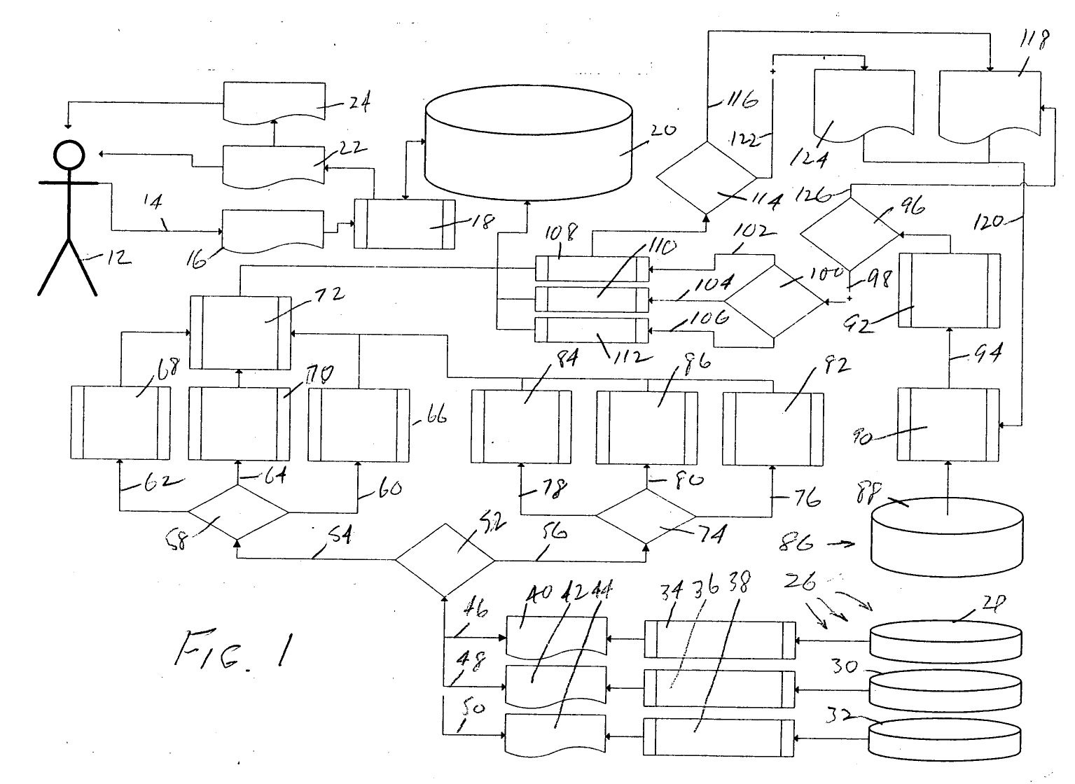

The BOMLS search engine is a web based system and built utilizing PHP scripting running on a Linux operating system. It is served over the Internet using an Apache web server. All of the data is stored in a MySq1 database. Referring to FIG. 1, the company's system data acquisition and user search function architecture will now be described.

Through a web form a user 12 enters search criteria and submits the request at 14 to the BOMLS system through the search page 16. The search engine 18 accepts the requests and based on the passed criteria scans through the listings database 20 and retrieves matching entries. Using HTML the extracted data is formatted into a presentable web page containing a table populated with listings and delivered to the user via search results page 22. Each listing on the search results page 22 is hyperlinked to a corresponding property details page 24. In order to retrieve a desired details page from the search results page 22, user 12 generates a request to the system by clicking on one of the listed properties. The request query containing the desired property ID is sent to the server and passed on to the search engine 18. The search engine 18 queries the database 20 and extracts the requested listing based on its ID. Listing data is formatted into a web page using HTML and sent back to user 12.

BOMLS acquires its data from partner LCs 26. The data can be entered into BOMLS database using two primary methods, LMDF, the Listing Manager Data Feed System, or LMA, the Listing Manager Application programming interface.

LMDF is the BOMLS data processing system that extracts (pulls) the data from partner LC servers in form of text or XML formatted files. Partner LCs “A,” “B,” and “C” data files 28, 30, and 32 are stored on the external (partner LC managed) servers and must be accessible via HTTP or FTP. The LMDF architecture is that the LC partner generates or manually populates the content of each file based on BOMLS provided format and is responsible for maintaining the accuracy of the data. The partner LC “A” data passes through its LMDF formatted file generator 34, the partner LC “B” data passes through its LMDF formatted file generator 36, and the partner LC “C” data passes through its LMDF formatted file generator 38 to produce partner LC LMDF files 40, 42, and 44.

BOMLS runs a scheduled batch job which downloads the LMDF formatted files from partner servers at 46, 48, and 50, processes them based on their format and ultimately stores the processed data in the BOMLS listings database 20. LMDF inserts all new records that appear in the LMDF files. LMDF updates any record that has changed in the LMDF file. LMDF deletes all records from the BOMLS database which are no longer present in LMDF file.

Through use of the LMDF, BOMLS can process data formatted as Text or XML. The date is queried at 52 to determine if it is Text 54 or XML 56. If Text, it is queried at 58 to determine which of three commonly used (sub) formats it is, Pipe Separated Values (PSV) 60, Tab Separated Values (TSV) 62, or Comma Separated Values (CSV) 64. Regardless of the sub format, LMDF can recognize the structure of the data and use an appropriate processor 66, 68 and 70 in order to read it and send the data to the LMDF data processor 72. Thence it is sent to and stored in the database 20. All text formats must follow a predefined field order described in the appropriate specification document.

LMDF also interprets data 56 in an Excel XML format and RETS. LMDF XML data can also be accepted via a custom formatted XML, however a new parse must be written in order to be able to accept and interpret the data. The data is first queried at 74 to determine if it is LMDF XML 76, Excel XML 78, or a custom XML 80. It is then sent through the appropriate LMDF XML processor 82, Excel XML processor 84, or custom XML processor 86 to read it and send the data to the LMDF data processor 72. Thence it is sent to and stored in the database 20.

The LMA BOMLS data processing system is the alternative to the LMDF system and allows partner LCs 86 to manage their listings inventory on BOMLS in real time. LMA is used by partner LCs 86 with large data inventory 88 that is constantly being updated, as it gives them an instant access and full control of every listing they have on BOMLS. Partner LCs 86 using the LMA system must maintain their own implementation of the LMA Client software 90. LMA Client 90 is a program that monitors the state of partner LC inventory and automatically reacts to its changes by notifying the BOMLS LMA listener 92 of each change in form of a XML formatted message which is sent to the BOMLS LMA listener over the internet HTTP or HTTPS 94.

That message contains special tokens that contain LMA Client authentication information, execution instructions (Insert/Update/Delete) and listings. Upon receiving the message LMA will process the XML contained within it, and query to authenticate the partner LC at 96. If the partner LC is authenticated the message is sent via 98 to be queried again at 100 as to the message type. It may be an LMA insert 102, an LMA update 104, or an LMA delete 106. LMA performs necessary data manipulations as instructed by the LMA Client program using the LMA insert function 108, LMA update function 110, or LMA delete function 112, which result is sent to and stored in database 20. Upon successful execution LMA will issue a response message containing the status of execution 114. If the execution fails an error message will be issued and sent via 116 to the LMA error response 118 and then via 120 to the LMA Client program 90 of partner LC 86. If execution was successful, that message will be sent via 122 to LMA status response 124, thence via 120 to the LMA Client program 90 of partner LC 86. Finally partner LC 86 is also informed if authentication failed at 96. Negative authentication is sent via 126 to LMA error response 118 and then via 120 to the LMA Client program 90 of partner LC 86.

While the invention has been described, disclosed, illustrated, and shown in various terms or certain embodiments or modifications which it has assumed in practice, the scope of the invention as defined in the claims is not intended to be, nor should it be deemed to be, limited thereby and such other modifications and embodiments as may be suggested by the teachings herein are particularly reserved especially as they fall within the breadth and scope of the appended claims.

What is claimed is:

1. A business method using an internet web site comprising:
gathering a plurality of by owner real estate listing companies (LCs) in any geographic location;
contracting with the LCs to post on the web site real estate listings offered for sale by their owners without realtors;
providing LCs with instructions on how to format data concerning the real estate listings;
establishing a web site database to store and maintain real estate listings; and
maintaining software on the web site accessible to LCs to send data concerning the real estate listings, to manipulate the data to put it in user friendly format, and to make the data searchable by a user.

2. The method of claim 1 which further comprises furnishing software to LC's for their use in formatting their real estate listing data to make it compatible with the web site software.

3. The method of claim 1 in which the web site further comprises a search page into which a user may input various parameters by which to search the database for real estate listings using such criteria as home, condominium, time share, rental, vacation home, town home, multi-family, vacant land and commercial listings.

4. The method of claim 1 in which the web site further comprises a search results page to display to a user data obtained from the database by a search.

5. The method of claim 1 in which real estate listings data stored in the database are structured into basic data and detailed data, the latter of which becomes visible when a user clicks on the former.

6. The method of claim 1 which further comprises the web site using software that extracts real estate listings data from LC servers in a location remote from a location of the web site.

7. The method of claim 1 in which the LCs are responsible for the maintaining the accuracy of the real estate listings data furnished to the web site database.

8. The method of claim 1 which further comprises the web site using software that enables LCs to manage their real estate listings data in the database in real time with instant access and full control from locations remote from a location of the web site.

9. The method of claim 8 which further comprises furnishing software to LCs that enables LCs to manage their real estate listings data in the database in real time from locations remote from a location of the web site using insert, update, and delete functions.

10. The method of claim 1 which further comprises the web site using software that reports to LCs successful vs. unsuccessful manipulation of their real estate listings in the database.

11. The method of claim 1 which further comprises the web site using software that reports to LCs successful vs. unsuccessful authentication of the LC identity qualifying the LC to manipulate real estate listings in the database.

12. The method of claim 1 which further comprises the web site providing potential sellers of real estate with a referral to an LC that has contracted to post real estate listings on the web site.

13. The method of claim 1 which further comprises the web site owner and LC's dividing seller listing fees charged by LCs.

14. The method of claim 1 which further comprises carrying advertising on web site to produce revenue to the web site owner.
